(19) United States
(12) Patent Application Publication
(10) Pub. No.: US 2024/0306780 A1
(43) Pub. Date: Sep. 19, 2024

(54) COUPLERS FOR PORTABLE TRACKING DEVICES

(71) Applicant: Daniel Joseph Teeny, Fairview, OR (US)

(72) Inventor: Daniel Joseph Teeny, Fairview, OR (US)

(21) Appl. No.: 18/660,968

(22) Filed: May 10, 2024

(51) Int. Cl. A45C 1/06; A45C 11/32; G01S 11/02

(52) U.S. Cl. CPC A45C 1/06; G01S 11/02; A45C 2001/067; A45C 11/321

(57) ABSTRACT

Couplers for portable tracking devices. The couplers include a body and an interface member. The body has a planar shape. The interface member is coupled to the body and complementarily configured with a portable tracking device. The interface member is configured to selectively insert into a recess defined in the portable tracking device. In some examples, the body defines a mount for an object. In certain examples, the object is a memory card and the mount is complementarily configured with the memory card. In certain examples, the object is a key and the mount is complementarily configured with the key.

### BACKGROUND

The present disclosure relates generally to couplers. In particular, couplers for portable tracking devices are described.

Portable tracking devices are popular to keep track of items and to locate misplaced or stolen possessions. Portable tracking devices are configured to wirelessly broadcast their location to enable compatible electronic devices, such as smart phones, tablet computers, and laptop computers, to locate them. Portable tracking devices are typically placed on or in items a person wants to readily locate and avoid losing.

Handling and using portable tracking devices presents a few challenges. For example, securing a portable tracking device to a desired object is a challenge with current solutions. Without an effective way to couple the portable tracking device to an object, the portable tracking device can easily become separated from the object. If a portable tracking device becomes separated from an object, the broadcasted location of the device may not correspond to the location of the object the portable tracking device was intended to track.

The small size of portable tracking devices can make them hard to find when they are surrounded by other items. For example, small portable tracking devices can be hard to find among clothes, shoes, and toiletries in a suitcase. The locating features of the portable tracking device typically lack sufficient resolution to identify specifically where in a bag, drawer, or container the device is located.

It would be beneficial if an apparatus existed to effectively couple a portable tracking device to another object. It would be helpful if the apparatus enabled portable tracking devices to easily and quickly mount and unmount to the apparatus. Additionally helpful would be an apparatus that also enabled accessories to conveniently and securely mount to the apparatus along with the portable tracking device to couple them together. Desirably, the apparatus would be thin and compact, yet still easy to locate.

Thus, there exists a need for couplers for portable tracking devices that improve the utility of portable tracking devices and aid in their use to track objects. Examples of new and useful couplers for portable tracking devices relevant to the needs existing in the field are discussed below.

### SUMMARY

The present disclosure is directed to couplers for portable tracking devices. The couplers include a body and an interface member. The body has a planar shape.

The interface member is coupled to the body and complementarily configured with a portable tracking device. The interface member is configured to selectively insert into a recess defined in the portable tracking device.

In some examples, the body defines a mount for an object to be tracked by the portable tracking device. In certain examples, the object is a memory card and the mount is complementarily configured with the memory card. In certain examples, the object is a key and the mount is complementarily configured with the key.

### BRIEF DESCRIPTION OF THE DRAWINGS

FIG. 1 is a top perspective view of a first embodiment of a coupler for a portable tracking device securing a portable tracking device, a key, a large memory card, and a small memory card.

FIG. 2 is a top perspective view of the coupler shown in FIG. 1 with the portable tracking device, the key, and the memory cards spaced from the coupler to demonstrate how the coupler is complementarily configured with them.

FIG. 3A is a top plan view of the coupler shown in FIG. 1 with the portable tracking device, the key, and the memory cards mounted to the coupler.

FIG. 3B is a top plan view of the coupler shown in FIG. 1 with the portable tracking device, the key, and the memory cards removed.

FIG. 4A is a front elevation view of the coupler shown in FIG. 1 with the portable tracking device, the key, and the memory cards mounted to the coupler.

FIG. 4B is a front elevation view of the coupler shown in FIG. 1 with the portable tracking device, the key, and the memory cards removed.

FIG. 5A is a bottom view of the coupler shown in FIG. 1 with the portable tracking device, the key, and the memory cards mounted to the coupler.

FIG. 5B is a bottom view of the coupler shown in FIG. 1 with the portable tracking device, the key, and the memory cards removed.

FIG. 6A is a top perspective view of a second embodiment of a coupler for a portable tracking device with three large memory card mounts and three large memory cards mounted into the memory card mounts.

FIG. 6B is a top perspective view of the coupler shown in FIG. 6A with the portable tracking device and memory cards removed.

FIG. 7A is a top plan view of the coupler shown in FIG. 6A securing a portable tracking device and memory cards.

FIG. 7B is a top plan view of the coupler shown in FIG. 6A with the portable tracking device and memory cards removed.

### DETAILED DESCRIPTION

The disclosed couplers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various couplers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising.” “including.” and “having” (and conjugations thereof) are used interchangeably to mean including but not necessarily limited to, and are open-ended terms not intended to exclude additional elements or method steps not expressly recited.

Terms such as “first”. “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Couplers for Portable Tracking Devices

With reference to the figures, couplers for portable tracking devices will now be described. The couplers discussed herein function to selectively retain a portable tracking device. In some examples, the couplers further function to support objects to be tracked by a portable tracking device, such as memory cards and/or keys.

The reader will appreciate from the figures and description below that the presently disclosed couplers for portable tracking devices address many of the challenges associated with using portable tracking devices currently. For example, the novel couplers disclosed herein effectively couple a portable tracking device to another object to be tracked to avoid the portable tracking device becoming separated from the object.

The novel couplers described below enable portable tracking devices to easily and quickly mount and unmount to them. Further, the novel couplers also enable objects to conveniently and securely mount to the coupler along with the portable tracking device to couple them together. Desirably, the novel couplers are thin and compact, yet still easy to locate when surrounded by other items.

### Contextual Details

Ancillary features relevant to the couplers described herein will first be described to provide context and to aid discussing the couplers.

### Portable Tracking Device

The couplers disclosed herein selectively support a portable tracking device. Portable tracking devices are configured to wirelessly broadcast their location to enable compatible electronic devices, such as smart phones, tablet computers, and laptop computers, to locate them. Portable tracking devices are typically placed on or in items a person wants to readily locate and avoid losing. For example, people may place portable tracking devices in a wallet, in luggage, in a vehicle, or on a person or animal, such a child or pet.

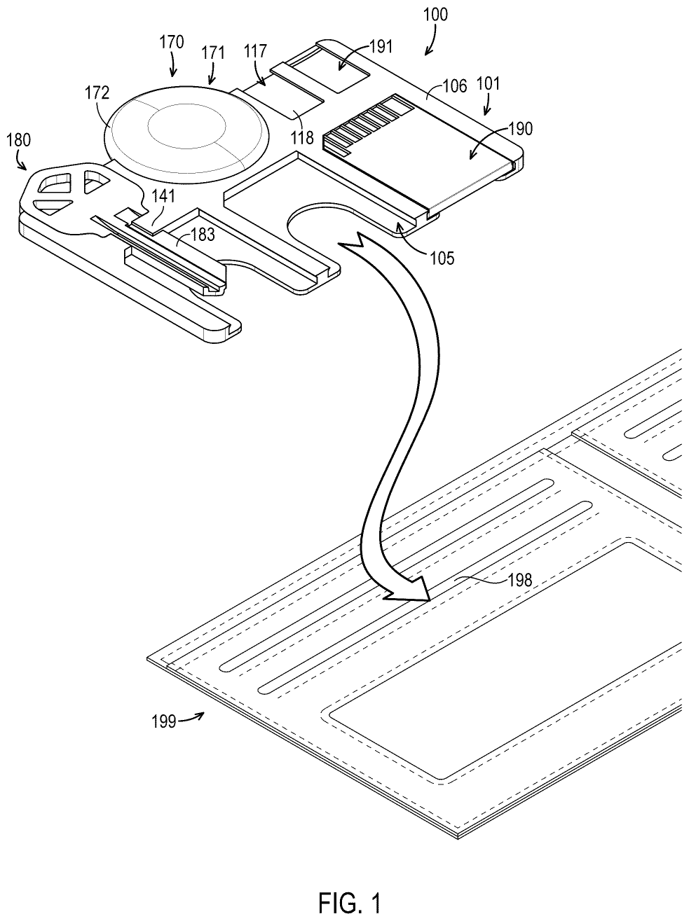

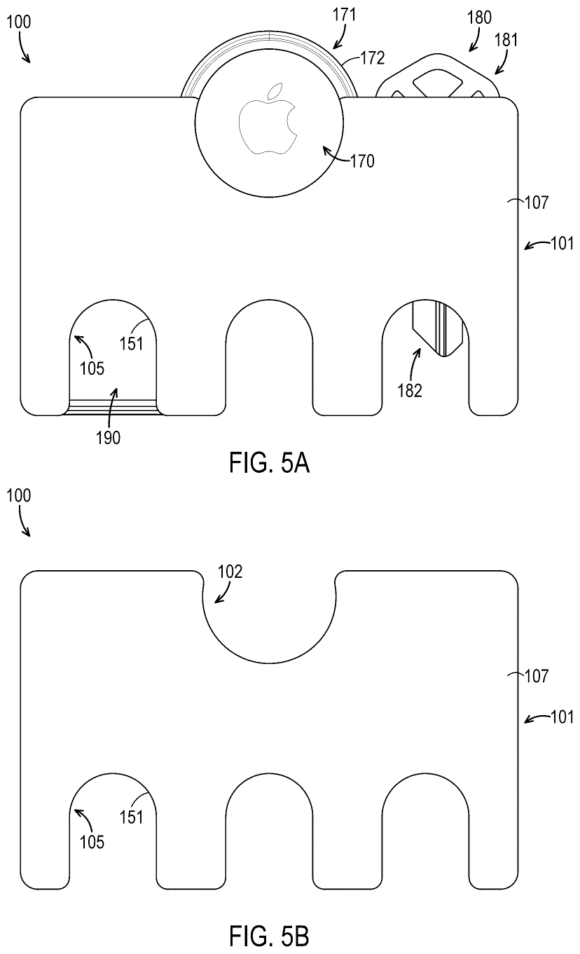

A variety of portable tracking devices exist. One popular example is the Apple® AirTag® portable tracking device. FIGS. 1-3A, 4A, 5A, 6A, and 7A depict a portable tracking device 170, which is an Apple® AirTag® portable tracking device. However, the couplers described herein can be adapted to selectively support other types of portable tracking devices.

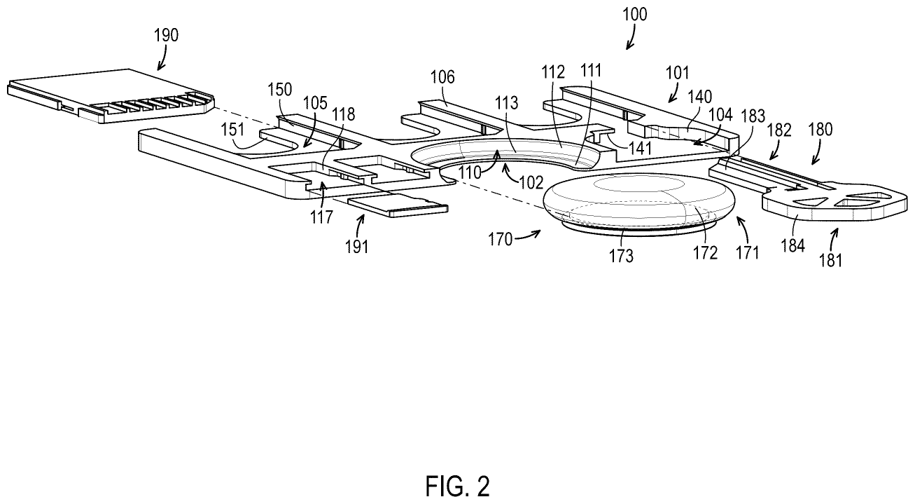

As shown in FIG. 1-3A, 4A, 5A, 6A, and 7A, portable tracking device 170 includes a housing 171. Housing 171 contains electronic components enabling portable tracking device 170 to broadcast its location. With reference to FIG. 2, one can see that housing 171 includes a curved outer surface 172 and defines a recess 173.

In the example shown in FIG. 1-3A, 4A, 5A, 6A, and 7A, curved outer surface 172 is convexly curved. With reference to FIG. 2, it is apparent that recess 173 extends circumferentially along curved outer surface 172. As explained in more detail below, coupler 100 interfaces with curved outer surface 172 and recess 173 to selectively support portable tracking device 170.

### Objects

The couplers disclosed herein selectively support one or more objects a user desires to track with a portable tracking device. The couplers described below may be configured to selectively support a wide variety of objects. Three suitable objects, a key 180, a large memory card 190, and a small memory card 191, are depicted in the figures. However, the novel couplers discussed herein may selectively couple many other types of objects to a portable tracking device via analogous complementary configurations as described below for key 180, large memory card 190, and small memory card 191.

As shown in Figs. FIGS. 1-3A, 4A, and 5A, key 180 includes a bow or head 181 and a blade or shank 182. As shown in the figures, key 180 is substantially planar with two major faces and a minor peripheral edge extending between the major faces. Key 180 has an outer profile 184 along which the minor peripheral edge extends around key 180.

As shown in FIGS. 1-3A and 4A, blade 182 defines a groove 183 that extends longitudinally. As explained further below, coupler 100 interfaces with groove 183 to selectively secure key 180. Coupler 100 also interfaces with outer profile 184 of key 180 to selectively secure key 180.

The reader can see in FIGS. 1-3A, 4A, 5A, 6A, and 7A that large memory card 190 and small memory card 191 are substantially planar with top and bottom major faces and relatively short edges. Memory cards 190 and 191 each define an outer profile. The couplers described herein are complementarily configured with the outer profiles of memory cards 190 and 191 to selectively secure them.

### Coupler Embodiment One

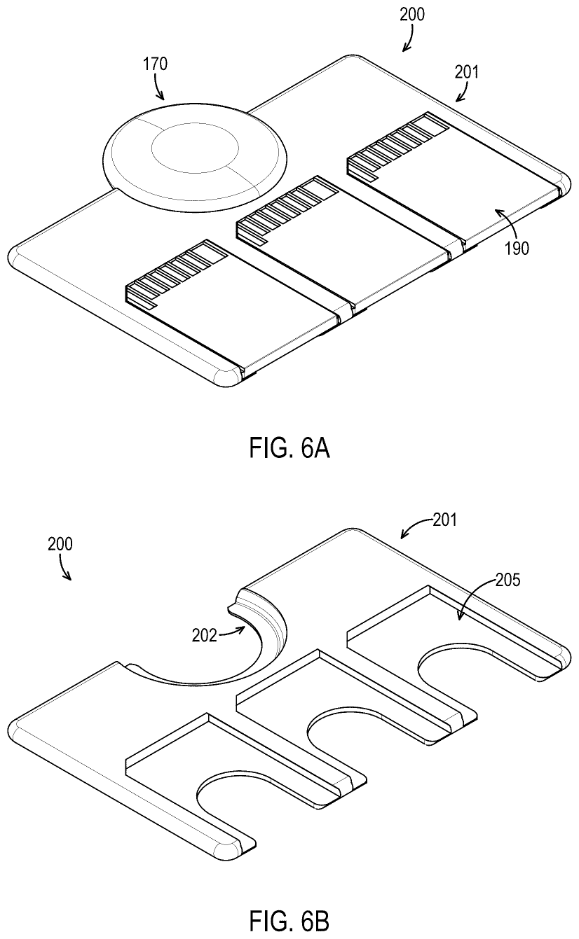

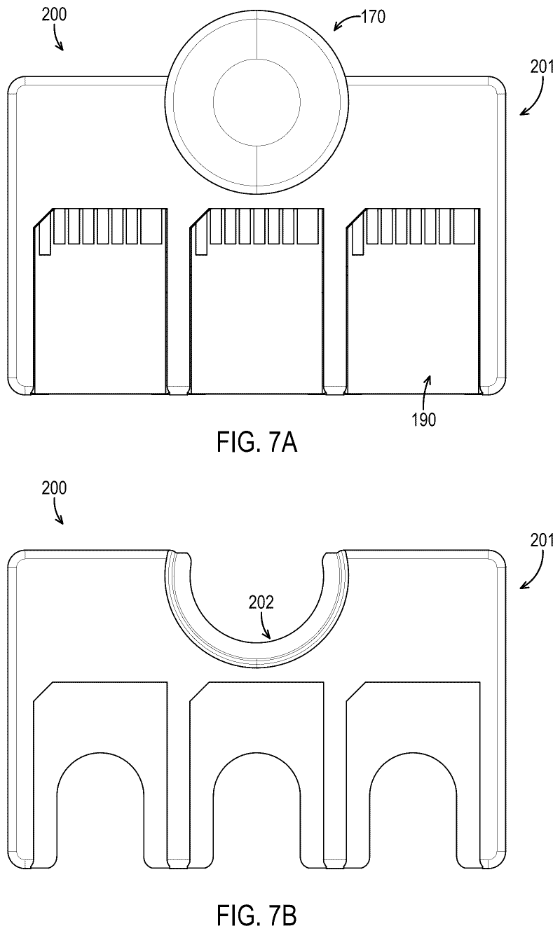

With reference to FIGS. 1-5B, a first example of a coupler, coupler 100, will now be described. A second example of a coupler, a coupler 200, is shown in FIGS. 6A-7B and described further below.

As depicted in FIGS. 1-5B, coupler 100 includes a body 101 and an interface member 102. In some examples, the coupler does not include one or more features included in coupler 100. In other examples, the coupler includes additional or alternative features.

The overall size and shape of the coupler may be varied for different applications. For example, as shown in FIG. 1, coupler 100 is complementarily configured with a credit card sleeve 198 of a wallet 199. Coupler 100 is configured to be comparable in size and shape to a credit card to enable it to selectively insert within credit card sleeve 198.

The couplers need not be configured to insert into credit card sleeve 198 in all examples, and some examples are too large or not the right shape to fit into credit card sleeve 198. However, coupler 100 being configured to insert into credit card sleeve 198 may make it more convenient to transport and keep track of coupler 100. Further, coupler 100 being configured to insert into credit card sleeve 198 effectively couples portable tracking device 170 to wallet 199, which aids with locating wallet 199 in the event it is misplaced or stolen.

### Body

Body 101 functions to support interface member 102. Body 101 also functions to selectively support objects, such as key 180, large memory card 190, and small memory card 191.

In the present example, interface member 102 is integrally coupled to body 101. However, in other examples, the interface member is a separate component coupled to the body by a suitable means, such as mechanical fasteners, adhesives, or magnets.

As shown in FIGS. 1-5B, body 101 has a planar shape. In other examples, the body has significant length, width, and height dimensions. The planar shape of body 101 is selected to enable coupler 100 to selectively insert into credit card sleeve 198 of wallet 199.

Describing the planar shape of body 101 in more detail and with reference to FIGS. 1-5B, body 101 includes a first major face 106 and a second major face 107. Second major face is disposed opposite first major face 106. The reader can see in FIGS. 1-4B that a key mount 104, large memory card mounts 105, and small memory card mounts 117 are defined recesses in first major face 106. Interface member 102 is also defined in first major face 106.

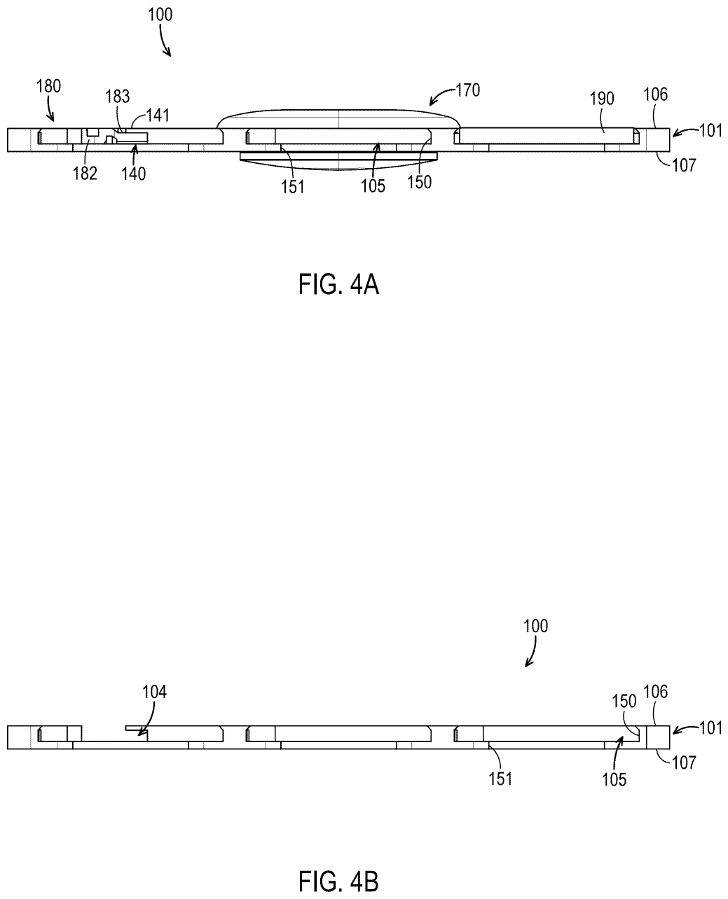

In contrast to first major face 106 which has various recesses defined in it, FIGS. 4A-4B demonstrate that second major face 107 has a level surface without recesses defined in it.

The reader can see in FIGS. 1-5B that body 101 defines multiple mounts for objects to be coupled to portable tracking device 170, including key mount 104, large memory card mounts 105, and small memory card mounts 117. The mounts serve to selectively support objects one may wish to link to portable tracking device 170 to facilitate locating them. Suitable objects depicted in the figures are key 180, large memory card 190, and small memory card 191.

To selectively support key 180, key mount 104 defines a key receiver recess 140 complementarily configured with key 180. As shown in FIGS. 1-4B, key receiver recess 140 closely conforms to outer profile 184 of key 180. Key receiver recess 140 receives key 180 and abuts the minor peripheral edge of key 180 to laterally bound key 180.

To further support key 180, key receiver recess defines a tab 141. Tab 141 is complementarily configured with groove 183 defined in key 180. Tab 141 is configured to selectively insert into groove 183 of key 180. Tab 141 functions to secure key 180 in key receiver recess 140 when tab 141 inserts into groove 183.

Turning attention to selectively supporting large memory card 190, large memory card mounts 105 each define a large card receiver recess 150. As is apparent in FIGS. 1-4B, large card receiver recess 150 is complementarily configured with large memory card 190. Large card receiver recess 150 selectively secures large memory card 190 via a friction fit when large memory card 190 is inserted into large card receiver recess 150.

As shown in FIGS. 1-5B, large card receiver recess 150 defines a finger opening 151 extending through body 101. Finger opening 151 enables a user to more easily grasp large memory card 190 from opposite major sides of body 101 when large memory card 190 is secured in mount recess 150.

The shape of finger openings 151 is rectangular with a curved end and the size is selected to accommodate a user's finger. However, the size and shape of the finger opening may vary in different examples. Not all examples of the large card receiver recess include a finger opening.

To selectively support small memory card 191, small memory card mounts 117 each define a small card receiver recess 118. As is apparent in FIGS. 1-4B, small card receiver recess 118 is complementarily configured with small memory card 191. Small card receiver recess 118 selectively secures small memory card 191 via a friction fit when small memory card 191 is inserted into small card receiver recess 118.

In the present example, body 101 is formed from plastic. However, the body may be formed from any currently known or later developed material suitable for supporting a portable tracking device and an object to be tracked. Suitable materials include metals, polymers, wood, and composite materials.

### Interface Member

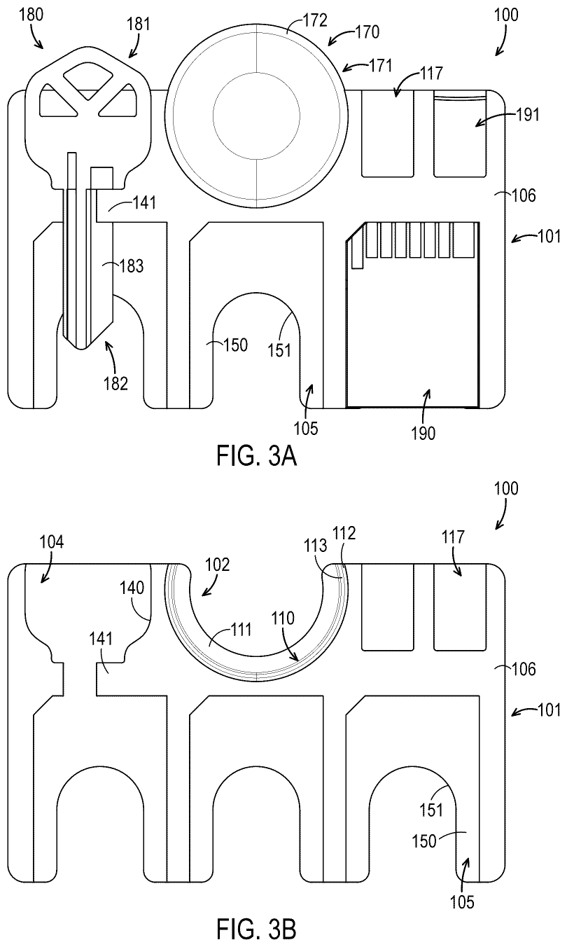

Interface member 102 functions to selectively couple with and support portable tracking device 170. As shown in FIGS. 2 and 3B, interface member 102 is complementarily configured with portable tracking device 170. In particular, Interface member 102 is configured to interface with both recess 173 and curved outer surface 172 of housing 171 of portable tracking device 170.

To interface with recess 173 and selectively couple with portable tracking device 170, interface member 102 is configured to selectively insert into recess 173. As shown in FIGS. 2 and 3B, interface member 102 is curved to complement recess 173, which extends circumferentially along curved outer surface 172. In particular, interface member 102 is concavely curved to complement the convex curve of curved outer surface 172.

In more detail and as shown in FIGS. 2 and 3B, interface member 102 includes a curved sidewall 110 and a curved rim 111. Curved rim 111 projects transversely from curved sidewall 110. Further, curved rim 111 is configured to insert into recess 173 of portable tracking device 170.

Curved sidewall 110 functions to interface with curved outer surface 172. As shown in FIGS. 2 and 3B, curved sidewall 110 is configured to receive and abut curved outer surface 172 of portable tracking device 170. In particular, curved sidewall 110 receives and abuts curved outer surface 172 when curved rim 111 is inserted into recess 173 of portable tracking device 170. Curved outer surface 172 is therefore supported by curved sidewall 110.

As shown in FIGS. 2 and 3B, curved sidewall 110 has a tapered profile. The tapered profile complements the outer profile of curved outer surface 172. In the present example, the tapered profile is defined by discrete curved walls 112 and 113. However, in other examples, the tapered profile is defined by a continuously tapered, single curved wall.

With reference to FIGS. 2 and 3B, the curved sidewall includes a first curved wall 112 and a second curved wall 113. Second curved wall 113 is proximate curved rim 111 and disposed between curved rim and first curved wall 112. In some examples, additional discrete curved walls beyond the two shown in FIGS. 2 and 3B are included. In certain examples, the curved sidewall does not include discrete curved walls and instead is a single curved wall.

As is apparent in FIG. 3B, first curved wall 112 has a first curvature radius, second curved wall 113 has a second curvature radius, and curved rim 111 has a third curvature radius. In the present example, the second curvature radius is smaller than the first curvature radius. Further, the third curvature radius is smaller than the second curvature radius. The relative curvature radii may be varied to complement the shape of a given portable tracking device.

### Additional Embodiments

With reference to the figures not yet discussed, the discussion will now focus on an additional coupler embodiment. The additional embodiment includes many similar or identical features to coupler 100. Thus, for the sake of brevity, each feature of the additional embodiment will not be redundantly explained. Rather, key distinctions between the additional embodiment and coupler 100 will be described in detail and the reader should reference the discussion above for features substantially similar between the different coupler examples.

### Coupler Embodiment Two

Turning attention to FIG. 6A-7B, a second example of a coupler, coupler 200, will now be described. As can be seen in FIGS. 6A-7B, coupler 200 includes a body 201 and an interface member 202.

The primary distinction between coupler 200 and coupler 100 is that coupler 200 does not include a key mount or small memory card mounts. Instead, coupler 200 includes three large memory card mounts 205 and presents a comparatively more streamlined profile than compared to coupler 100. Coupler 200 demonstrates that it can be configured to couple different objects to a portable tracking device as desired for a given application.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element. “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

Semi-circle male projection complementarily configured with a female recess defined in a portable tracking device

1. A coupler for a portable tracking device, the coupler comprising:
a body having a planar shape; and
an interface member coupled to the body and complementarily configured with the portable tracking device;
wherein the interface member is configured to selectively insert into a recess defined in the portable tracking device.

2. The coupler of claim 1, wherein:
the portable tracking device includes a curved outer surface;
the recess of the portable tracking device extends circumferentially along the curved outer surface; and
the interface member is curved to complement the recess extending circumferentially along the curved outer surface.

3. The coupler of claim 2, wherein:
the curved outer surface is convexly curved; and
the interface member is concavely curved.

4. The coupler of claim 2, wherein the interface member includes:
a curved sidewall; and
a curved rim projecting transversely from the curved sidewall.

5. The coupler of claim 4 wherein the curved rim is configured to insert into the recess of the portable tracking device.

6. The coupler of claim 5, wherein the curved sidewall is configured to receive and abut the curved outer surface of the portable tracking device when the curved rim is inserted into the recess of the portable tracking device.

7. The coupler of claim 6, wherein the curved sidewall has a tapered profile.

8. The coupler of claim 7, wherein the tapered profile is defined by discrete curved walls.

9. The coupler of claim 8, wherein the curved sidewall includes:
a first curved wall having a first curvature radius; and
a second curved wall having a second curvature radius smaller than the first curvature radius.

10. The coupler of claim 9, wherein the second curved wall is proximate the curved rim.

11. The coupler of claim 10, wherein the curved rim has a third curvature radius smaller than the second curvature radius.

12. The coupler of claim 1, wherein the body defines a mount for an object.

13. The coupler of claim 12, wherein:
the object is a memory card;
the mount defines a card receiver recess complementarily configured with the memory card; and
the card receiver recess selectively secures the memory card via a friction fit when the memory card is inserted into the card receiver recess.

14. The coupler of claim 13, wherein the card receiver recess defines a finger opening extending through the body to enable a user to grasp the memory card from opposite major sides of the body when the memory card is secured in the card receiver recess.

15. The coupler of claim 12, wherein:
the object is a key; and
the mount defines a key receiver recess complementarily configured with the key.

16. The coupler of claim 15, wherein:
the key receiver recess defines a tab that is complementarily configured with a groove defined in the key; and
the tab is configured to selectively insert into the groove of the key to secure the key in the key receiver recess.

17. The coupler of claim 12, wherein:
the body includes:
a first major face on which the mount and the interface member are defined; and
a second major face opposite the first major face; and
the second major face has a level surface without recesses defined in it.

18. The coupler of claim 1, wherein the body is formed from plastic.

19. The coupler of claim 1, wherein the coupler is complementarily configured with a credit card sleeve to selectively insert within the credit card sleeve.

20. The coupler of claim 1, wherein the interface member is integrally coupled to the body.
